(19) United States
(12) Patent Application Publication
(10) Pub. No.: US 2009/0236415 A1
(43) Pub. Date: Sep. 24, 2009

(54) RESCUE TRACK AND LOCATE NAME BADGE

(75) Inventors: Kenneth S. Bailey, Newport Beach, CA (US); Paul Mula, San Jose, CA (US)

Correspondence Address: Law Office of Scott C Harris Inc, PO Box 1389, Rancho Santa Fe, CA, 92067, US

(73) Assignee: CLEAR-VIEW TECHNOLOGIES, INC, San Jose, CA (US)

(21) Appl. No.: 12/359,428

(22) Filed: Jan. 26, 2009

Related U.S. Application Data
(60) Provisional application No. 61/023,323, filed on Jan. 24, 2008.

(51) Int. Cl. G06K 5/00

(52) U.S. Cl. 235/380

(57) ABSTRACT

A name badge which has wireless capabilities. The name badge is normally maintained in a power reduced states, but detects an excitation signal from a remote antenna and turns on to provide ID information. The ID information can be associated with the transaction from the remote computer, and used to determine who initiated that transaction.

This application claims priority from application Ser. No. 61/023,323, filed Jan. 24, 2008, the entire contents of the disclosure of which is herewith incorporated by reference.

### BACKGROUND

Inventory shrinkage, a combination of employee theft, shoplifting, vendor fraud and administrative error, cost United States retailers over $41.6 billion in 2006 according to the latest National Retail Security Survey report on retail theft, which analyzed theft incidents from 118 of the largest U.S. retail chains representing 24 million employees at 1.6 million locations.

According to University of Florida criminologist Richard C. Hollinger, Ph.D., who directs the National Retail Security Survey, retailers lost 1.7 percent of their total annual sales to inventory shrinkage in 2006. The surveyed portion of the retail economy transacts over $4.7 trillion dollars annually, making the loss worth over $41.6 billion.

While total inventory shrinkage was down slightly in 2006, to 1.68 percent from 1.75 percent two years ago, both employee theft and shoplifting are on the rise. Inventory shrinkage remains the single largest category of larceny in the United States, more than motor vehicle theft, bank robbery and household burglary combined.

Hollinger warns that it isn't just retailers who should be concerned about retail theft. Retail theft impacts everyone. Ultimately it's consumers that are hurt the most in the form of higher prices.

“An average family of four will spend more than $540 next year in higher prices because of inventory theft,” Hollinger said. “Thieves also generally target hot selling items, which means those must-have toys on your child's holiday wish list are less likely to be available on the store shelves.”

| Source of Inventory Shrinkage | % of Loss* | $ Lost |
|---|---|---|
| Employee Theft | 47% | $19.5 billion |
| Shoplifting | 32% | $9.7 billion |
| Administrative Error | 14% | $5.8 billion |
| Vendor Fraud | 4% | $1.7 billion |
| Total Inventory Shrinkage | | $41.6 billion |

*total not equal to 100% due to rounding
Source: National Retail Survey, 2007 (2006 retail sales shrinkage)

The study, conducted by the University of Florida with a funding grant from ADT Security Services, Inc., a unit of Tyco Fire and Security Services, discovered that retail security managers attributed more than 47% percent of their losses to employee theft, up from 46 percent the prior year. Internal theft by employees cost retailers a record $19.5 billion.

### SUMMARY

A system is described that enables employers to identify employees wirelessly from battery powered name badges. The personnel are detected and identified as they come into close proximity to the base station or host located underneath or near the business's cash register.

### BRIEF DESCRIPTION OF THE DRAWINGS

### In the Drawings:

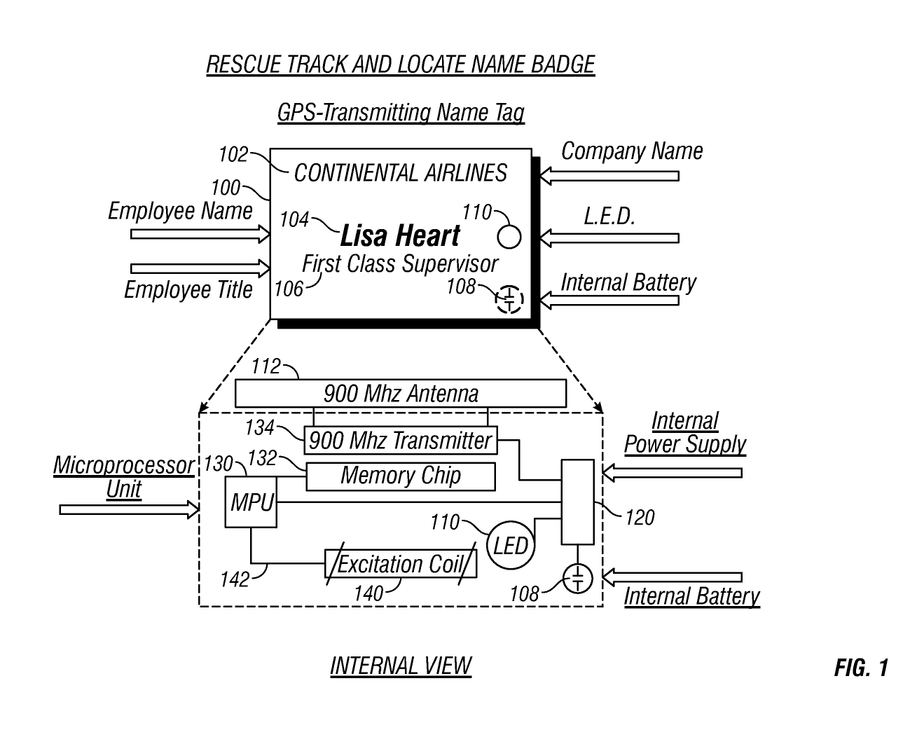

FIG. 1 shows a block diagram of the system;

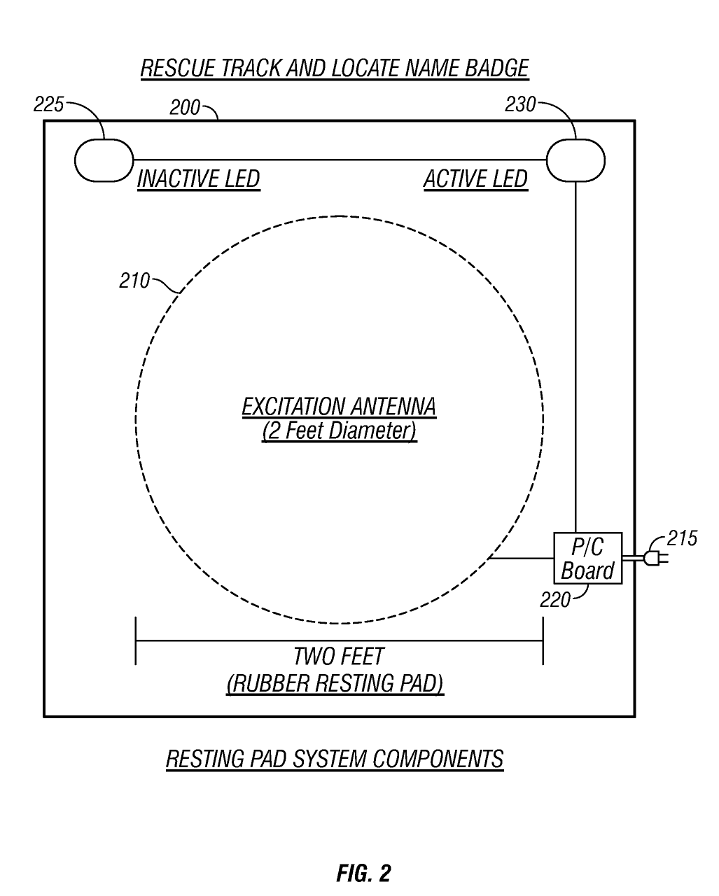

FIG. 2 shows an excitation antenna and its associated circuitry;

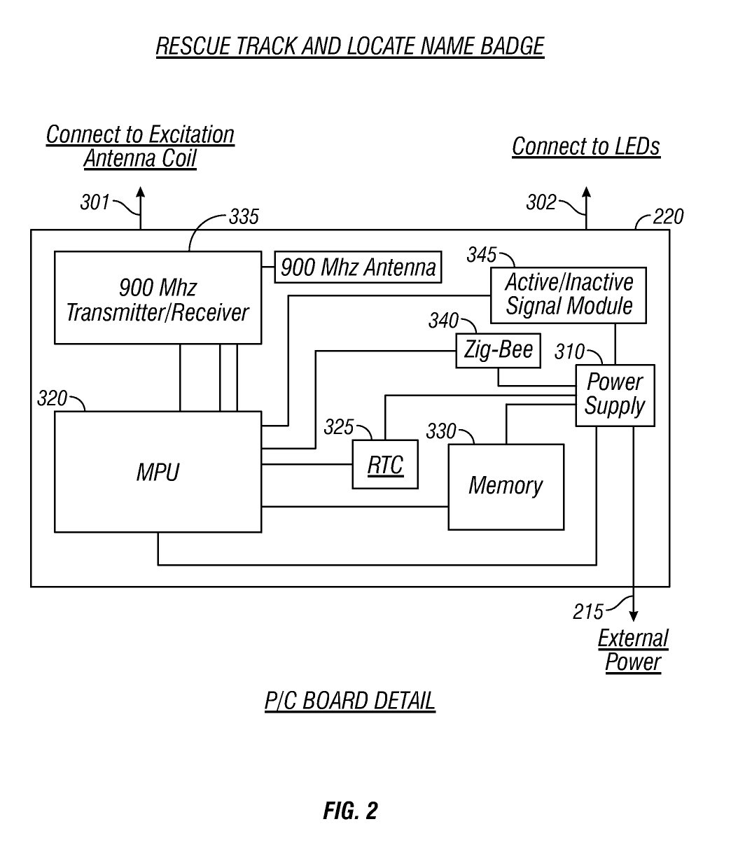

FIG. 3 shows a block diagram of the associated circuitry;

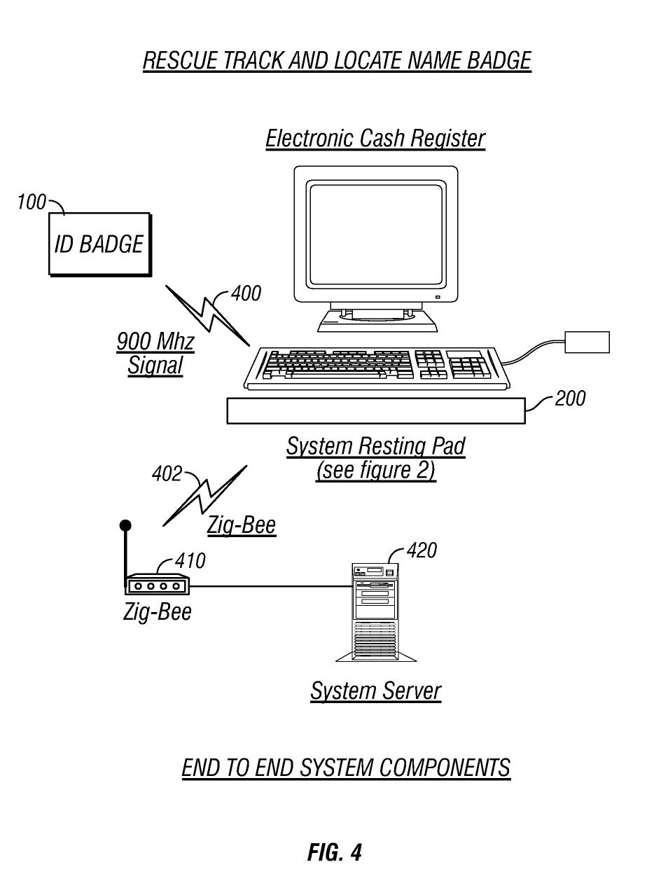

FIG. 4 shows a block diagram of the end to end system;

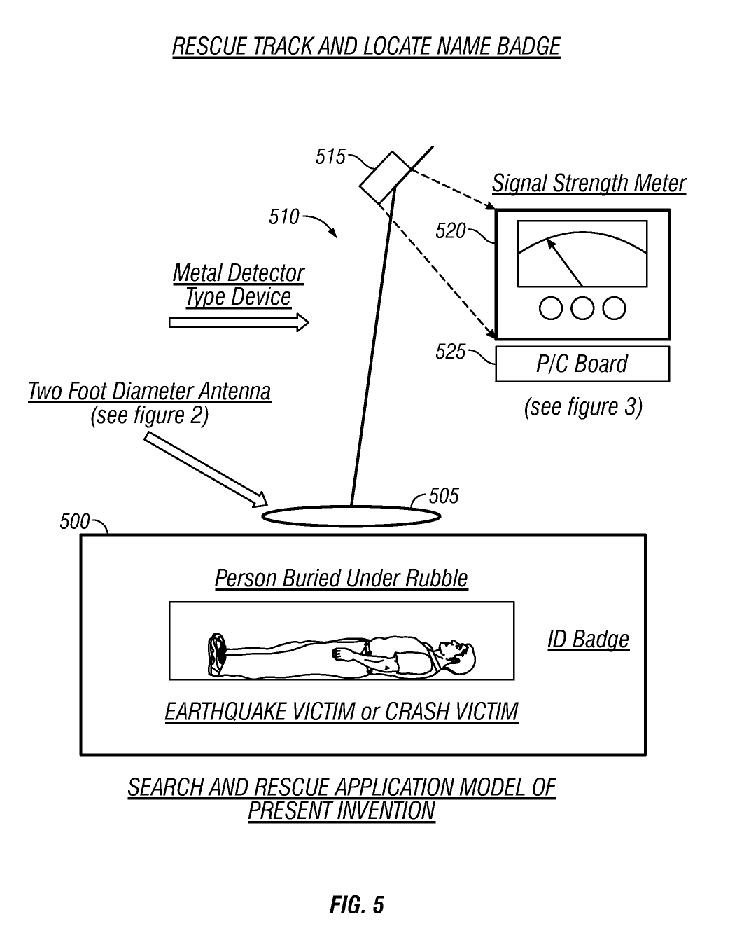

FIG. 5 shows an embodiment of using this system to find persons in an emergency; and

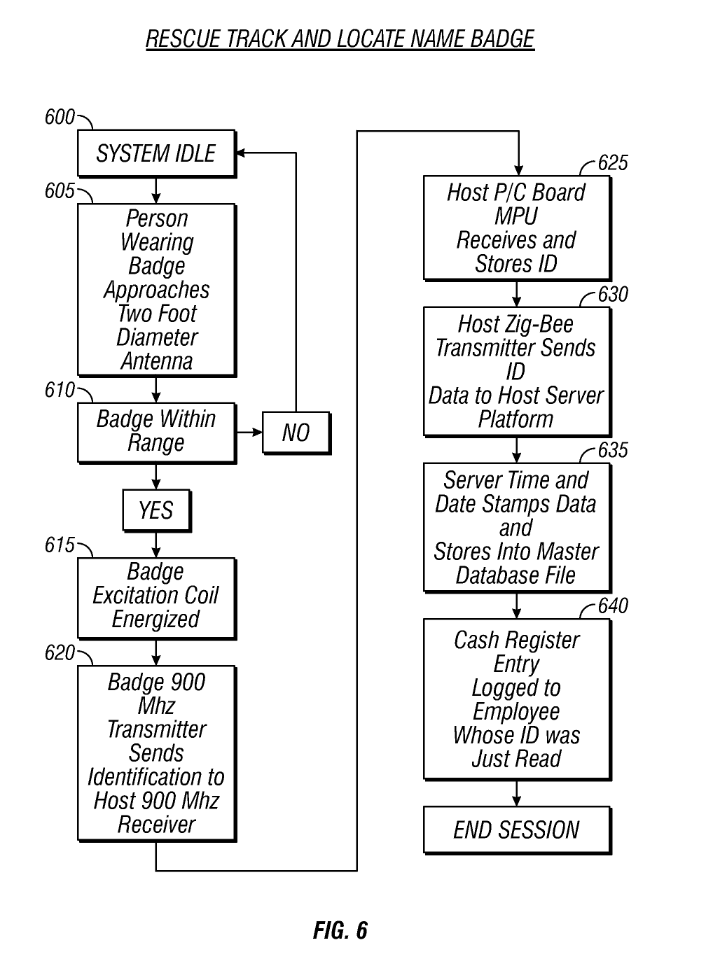

FIG. 6 shows a system flowchart.

### DETAILED DESCRIPTION

Employee theft of all types costs merchants and consumers alike, in terms of added cost to the goods sold or purchased.

An embodiment describes monitoring an employee who gets close to certain machinery.

In an embodiment, an employee approaches the cash register wearing a badge of the type disclosed in an embodiment. The badge transmits signals, such that when the employee gets to within two feet (or some other short distance representing a proximity) of the cash register, the employee's badge sends out a signal via a miniature transmitter located within the badge. The signal is received by a small receiver attached to a printed circuit board located in a resting pad beneath or near to the cash register.

When the employee is in that proximity, each transaction as rung up is time and date stamped, and forwarded to a server computer in a central office, e.g., the manager's office, via a wireless connection, such as Wifi or ZigBee. The received information is stored in the server computer's database. This information represents an amount of the transaction (e.g., how much cash was rung up) and the person doing the transaction.

The present inventor recognizes that this is an unexpectedly simple solution to the employee theft problem. The present system can track employees, and also can track both cash and inventory in a same way. Everything can be tracked from the time it arrives at the store, until it leaves the store, either sold or otherwise accounted for. The present inventors realized that at least one source of the employee theft problem is that there is no adequate way of accounting for who does certain selling functions in a store. By monitoring wirelessly persons' positions at times of transactions, this problem is addressed.

This allows determining positions of persons at times, and also determining times of transactions. By monitoring both, this allows determining ‘who’ rang up certain transactions, and and whether or not the proper amount of cash was collected.

In the case of larger department stores, modern cash registers require the employee to enter a password, or other employee identification codes, before the cash register will operate. Many millions more smaller establishments simply cannot afford the cost for such a modern price cash register. The embodiment is much more low cost and allows monitoring similar issues at a much lower cost and without expensive cash register hardware.

In an embodiment, the name badge has a battery (alkaline or rechargeable), a memory chip, a microprocessor chip, a proximity activation coil, a low power RF transmitter, an LED., a power supply and an antenna. The badge communicates with an electronics board, e.g. a PC board as part of a computer, located either under the cash register, housed within a rubber resting pad, or nearby the cash register.

When the employee approaches the cash register to ring up a customer purchase, the antenna coil at the cash register acts as an exciter and causes the exciter coil located within the employee's name badge to become excited. This wakes up the microprocessor within the badge from an idle or sleep state in which the battery consumption is minimized. The wake up causes the MPU to send a signal via the miniature transmitter located within the employee badge. The transmitted data is received at the PC board and transmitted to the remote server within the facility via wireless protocol, e.g., BlueTooth or Zig-Bee. The signal indicating who is close to the cash register, and hence is presumably operating the cash register is also time coded using the PC board internal time clock (RTC). All of this is sent to the remote server via wireless link as well. At approximately the same time, the wireless cash register sends a message to the remote server, either wirelessly or via Ethernet cable, to indicate how much cash was entered on the cash register.

Only the person within proximity of the cash register will have his or her name badge activated at that time. Since the badge in placed in a sleep mode while the employee is out of range of the cash register, the battery located within the employee's badge has a longer sustained power cycle. This enabling the badge to operate for many hours or days, without recharging or replacing the badge's internal battery. This can be important to minimize the number of times the battery will need charging.

The figures show further details of certain embodiments.

FIG. 1 depicts the employee's name badge with internal components. The badge has a plastic housing, a battery, a power supply, an excitation coil, a microprocessor unit, a memory storage device for storing the employee' s unique identification, a low powered transmitter, coupled to an antenna.

The badge 100 includes a number of fields thereon both written and electronically accessible. These fields may include company name 102, the employee name 104, and employee title 106. In addition, the name badge may include an internal battery 108, and an indicator 110 such as an LED. The internals of the system are shown, including a 900 MHz antenna 112, preferably located on a flat surface of the badge, preferably extending around, for example, a perimeter of at least a portion of the badge. The antenna is driven by the electronics that are located within the badge. These electronics are preferably flatpack housed devices.

The battery 108, for example, may drive a power supply 120 which may be a DC to DC converter, or may simply be a power junction area that connects to multiple different units. The power supply 120 drives a processor 130, and memory chip 132. It also drives a transmitter 134 which is substantially matched to the antenna 112. In operation, the processor and memory operate as described further herein. An excitation coil 140 is provided, and has an output 142 which is sampled by the processor.

In operation, the processor 130 causes all of the electronics to operate in a sleep mode except during a time when and immediately after, the excitation coil 140 is sensing an excitation. When in sleep mode, all of the electronic devices are turned off, including the LED 110. This may use conventional sleep mode electronics to determine operation.

Therefore, an employee wearing the name badge normally has this LED in the off position. However, when the employee comes within range of an exciter and appropriately turned on, the LED is correspondingly turned on.

FIG. 2 depicts the internal components of the “Resting Pad” as described more fully herein above. The PC board is comprised of a two foot diameter or similar, excitation antenna, two LEDs, indicating if the system detects the presence of the employee badge, and the rubber enclosure which contains and protects the PC board and other components of the resting pad portion of the system. The exciter shown in FIG. 2 has 200 represents the rubber resting pad, which may be associated with for example, a cash register or other device that accepts transactions. A large size excitation antenna 210 is provided. This excitation antenna for example, can be 2 feet in diameter, to produce sufficient amount of signal to be received by the much smaller excitation coil 140. This produces, for example, a magnetic signal that is received by that remote receiver, and which signals the microprocessor to turn on.

The rubber resting pad is itself connected to a source of AC power shown generally as 215. A PC board 220 carries out certain circuit operations as described herein.

Moreover, the excitation antenna may include two different LEDs, and inactive LED 225 which indicates that the system is inactive, and an active LED 230 which indicates that a system is active.

FIG. 3 depicts the PC board located beneath or near to the cash register that the employee uses to ring up transactions. The PC board has a miniature transceiver, an antenna, a wireless transceiver (such as Blue-Tooth or Zig-Bee), a power supply, a microprocessor (MPU), a Real Time Clock (RTC), a memory storage device, an active/inactive signaling circuit, and a rubber enclosure resting pad for the cash register. Outputs 301 of the PC board 220 goes to the antenna excitation coil, while an output 302 can connect to the LEDs. The system includes a power supply 310 which drives all of the different modules including the microprocessor 320, a real time clock 325, memory 330, transmitter receiver 335, and a network device 340 which may be a ZigBee network. The active/inactive signal module 345 may be a dedicated device that determines whether a name badge is within range, or may be implemented as part of the microprocessor 320.

The excitation coil can be a tubular coil or can be a flat coil, limited only by the packaging of the ID device. In some embodiments, it may be extremely advantageous to use flat components.

FIG. 4 depicts the entire end to end system, including the employee ID badge, the electronic cash register, the resting pad, the low power transceiver communicating with the employee ID badge, the Zig-Bee or BlueTooth transceiver unit, and the system remote server computer. FIG. 4 illustrates how the ID badge 100 can produce a wireless signal shown as 400, directed to the “resting pad” 200, that associates a person's proximity with real-time information. The circuitry in the resting pad 200 is sends information by the wireless communication, e.g. Zig Bee, to the receiver 410. This is connected to the system server 420, and records information about the transactions and for the person's proximity and the real time information. The system server may also associate this with other similar information.

FIG. 5 depicts the rescue and track embodiment of the employee ID (name) badge. The system contains a detector, using a metal detector type device, housing the P/C board as described in FIG. 3 above, wherein the P/C board has been made in such a manner that it becomes mobile and battery powered, in order to locate a victim of a plane crash, earthquake or other disaster that might be buried under some type of debris.

For example, in one embodiment, the ID badge is a wallet sized device, kept with the person at all times. When attempting to locate people, a large antenna 500 is used to excite the corresponding antenna in the lost person. This forms a metal detector type device 510. The outputs from the receiver are sent to a signal strength meter 520 which can be used, for example, to detect the location or proximity of persons who are difficult to find, such as earthquake victims or crash victims. The signals can be handled and processed in a PC board 525 which may operate in a similar way to that discussed above with respect to FIG. 3

FIG. 6 illustrates an end to end flowchart. The system starts out in sleep mode 600. At 605, a person wearing the badge approaches the large antenna. 610 determines if the badge is within range, and if so, at 615, the excitation coil 140 within the badge is energized.

At 620 this causes the badge to send its identification to the receiver 335 within the host. The host's electronic processor at 625 receives and stores the ID, and at 630 sends that ID along with data from the real time clock 325 to the host server platform. At 635, that server platform timestamps the data and stores it into a master database file. 640 logs the cash register entry using the real-time clock and associates it with the information from the badge.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other components can be used. While the above describes a location system for anti theft, The same wireless battery powered name badge can be used to locate victims of a disaster, such as an earthquake or plane crash utilizing a device resembling a metal detector. When the receiving device comes into close proximity to the victim, it reads the ID badge and determines who is buried under the rubble and where they are buried. Another embodiment, can hence be used to save lives in a disaster. Also, other similar structure can be used to determine location.

While the above has described very specific forms of structure and networks that can be used, other network protocols, including but not limited to Bluetooth and others can be similarly and analogously used. In addition, other applications for this system are possible and are contemplated by the present application.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A system comprising:
a portable badge that uniquely identifies an individual, said badge having a power supply that is normally in a condition in which it has a reduced power consumption, and in said reduced power consumption mode, said badge is stopped from performing an identification function and said badge also having a power increased function in which an identifier indicative of a person associated with said identifier is sent to a local receiver; and
an information accumulating part, receiving said identifier, and associating said identifier with a position of said information accumulating part, and with a time and date.

2. A system as in claim 1, wherein said information accumulating part detects only a badge that is within a proximity of said information accumulating part.

3. A system as in claim 1, wherein said information accumulating part turns on an operation of said badge when said badge is within a proximity of said information accumulating part, said turns on causing said power increased function.

4. A system as in claim 3, further comprising written materials on an outer surface of said badge, said written materials identifying a person wearing the badge.

5. A system as in claim 4, further comprising an indicator that lights to indicate said power increased function.

6. A device as in claim 1, further comprising an indicator lamp which is lit to indicate said power increased function.

7. A transaction register, comprising:
a transaction portion, which enables determination of transactions carried out by an employee;
a wireless detection portion, which wirelessly detects a proximity of a specified identification associated with said employee; and
an information sending part, that sends both said transaction information and said wirelessly determined information to a remote server.

8. A register as in claim 7, wherein said wireless detection portion detects an identification that indicates a specific person who is within range of, and operating, the transaction register.

9. A register as in claim 7, further comprising an excitation antenna that produces a signal to turn on a remote selected identification device, and circuitry which operates subsequent to turning on said remote identification, to read said information from the remote selected identification device.

10. A register as in claim 7, wherein said transaction register is a cash register.

11. A register as in claim 9, wherein said remote selected identification device is a portable badge that uniquely identifies an individual, said badge having a power supply that is normally in a condition in which it has a reduced power consumption, and in said reduced power consumption mode, said badge is stopped from performing an identification function and said badge also having a power increased function in which an identifier indicative of a person associated with said identifier is sent to said register.

12. A method, comprising: normally maintaining a battery-operated identification badge in a power reduced state;
detecting, in said battery-operated identification badge, a signal from a remote device, and turning on said battery-operated identification badge only upon detecting said signal from said remote device;
sending signals indicative of user unique information to said remote device; and
when not detecting said signal from said remote device, said battery operated identification badge entering said power reduced state.

13. A method as in claim 12, further comprising receiving said user unique information in a server, and associating said user unique information with a transaction.

14. Method as in claim 12, further comprising sending said user unique information along with transaction information and time information, to a remote server.
